(19) United States
(12) Patent Application Publication
(10) Pub. No.: US 2005/0248109 A1
(43) Pub. Date: Nov. 10, 2005

(54) Tool storage kit

(76) Inventor: Ting Wei Chang, Waipu Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/841,515

(22) Filed: May 10, 2004

(51) Int. Cl. B62B 1/00

(52) U.S. Cl. 280/79.3; 280/47.35

(57) ABSTRACT

A tool storage kit has a base with four wheels at corners of a bottom thereof on which at least a combinative chest is stacked and a lid is put on the top combinative chest. The base, the combinative chest and the lid are provided with coupling sets at their corners respectively. The coupling set has a first coupler of protrusion and a second coupler to receive the first coupler therein. The base, the combinative chest and the lid are firmly coupled with each other by the coupling sets. User can stack the combinative chests as many as he/she needs to meet the height of the workplace.

### BACKGROUND OF THE INVENTION

1. Field of the Invention

The present invention relates generally to a kit, and more particularly to a tool storage kit, which has flexibility in assembly and in height according to the workplace.

2. Description of the Related Art

In a workplace of fixing and assembling mechanical equipments, such as machines or automobiles, it always has tool storage kits to store tolls therein. The conventional storage kit usually has a fixed height and the height of the storage space is fixed too. In many workplaces, the mechanic has to work at various heights, such as the mechanics have to fix the engine or the chassis of an automobile or the mechanics have to work on machines with various heights. The fixed height of the tool storage kit is inconvenience to the one who has to work at various heights. It always happens to a automobile mechanic to pick up the tools from the storage kit and lie down under the truck to fix the chassis. Once he finds a tool not picking up, he has to get out, find the right tool in the storage tool and crawl back again. That is very inconvenient to the mechanics.

### SUMMARY OF THE INVENTION

The primary objective of the present invention is to provide a tool storage kit, which is free assembled type to meet the requirements of the users and can adjust the height thereof to facilitate users picking the tools out or storing them while they are working at various heights.

According to the objective of the present invention, a tool storage kit has a base with four wheels respectively at corners of a bottom thereof and a first end at a periphery of a top thereof. At least a combinative chest to be stacked on the base has an opening, a second end at a periphery of a bottom thereof and a first end at a periphery of a top thereof. The second end of the combinative chest is attached on the first end of the base. A lid is provided on the top of the combinative chest and having a second end at a periphery of a bottom thereof to be attached on the first end of the combinative chest. A plurality of coupling sets are provided at corners of the base, the combinative chest and the lid respectively. Each coupling set has a first coupler and a second coupler to be engaged with the first coupler, wherein the first couplers and the second couplers are disposed at corners of the first ends and the second ends respectively to couple the base, the combinative chest and the lid.

### BRIEF DESCRIPTION OF THE DRAWINGS

FIG. 1 is a perspective view of a first preferred embodiment of the present invention;

FIG. 2 is an exploded view of the first preferred embodiment of the present invention;

FIG. 3 is an enlarged perspective view in part of the first preferred embodiment of the present invention;

FIG. 4 is a sectional view of the first preferred embodiment of the present invention;

FIG. 5 is an exploded view in part of a second preferred embodiment of the present invention, and

FIG. 6 is a sectional view of the second preferred embodiment of the present invention.

### DETAILED DESCRIPTION OF THE INVENTION

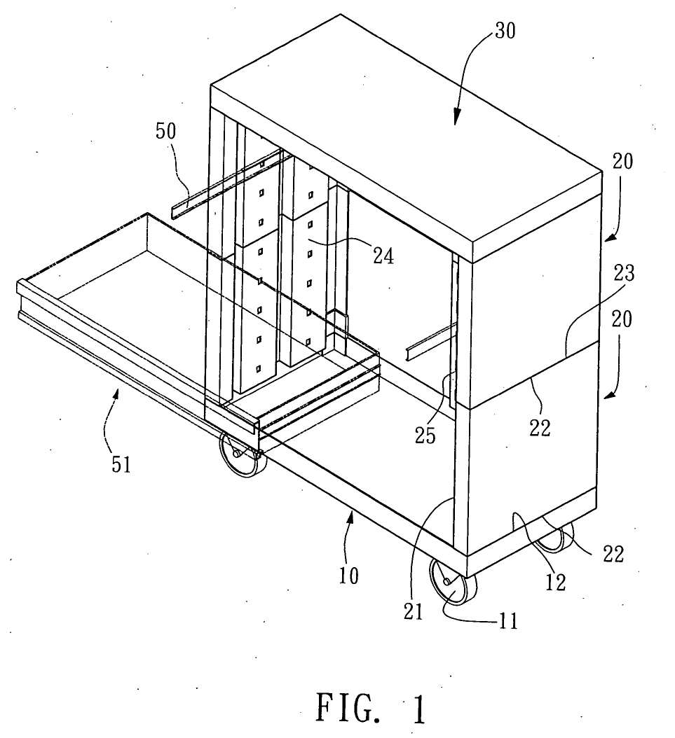

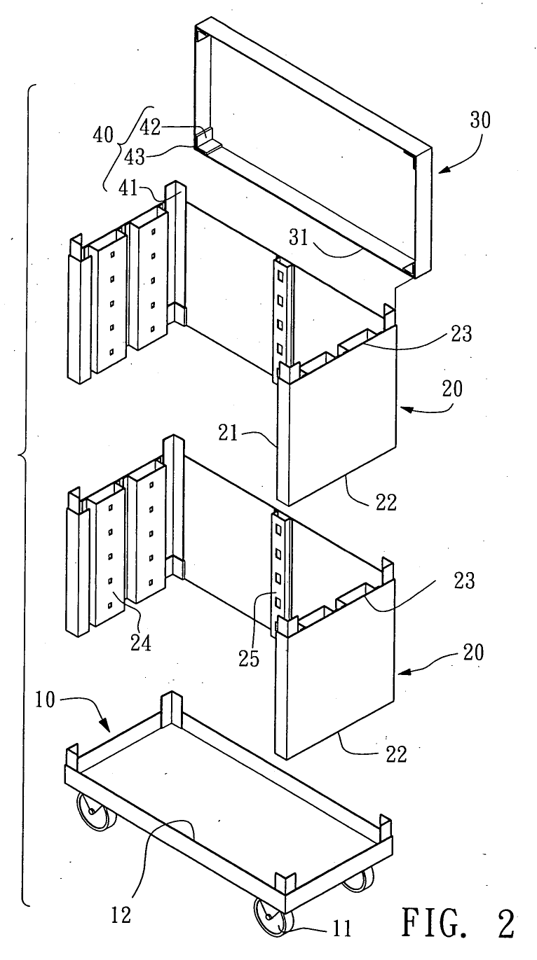

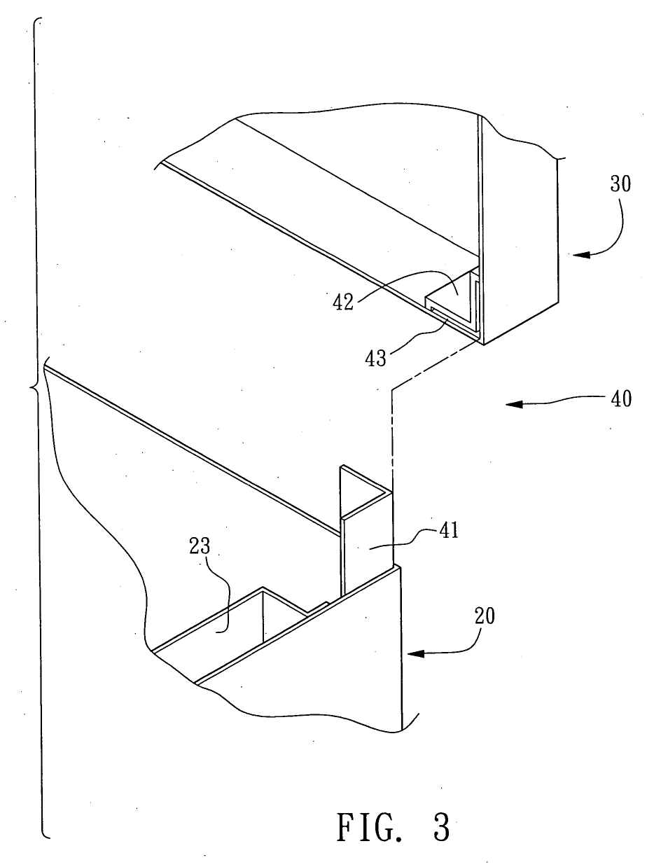

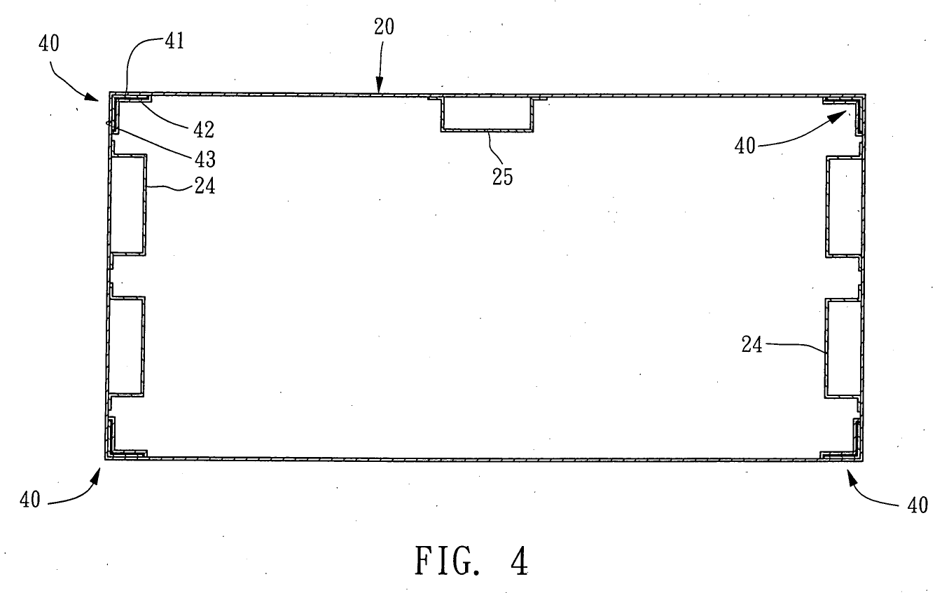

As shown in FIGS. from FIG. 1 to FIG. 4, a tool storage kit of the first preferred embodiment of the present invention comprises:

A base 10 is provided with four wheels 11 respectively at four corners of a bottom thereof. The base 10 has a first end 12 at a top thereof.

A least a combinative chest 20, there are two combinative chests 20 shown in the drawings of the first preferred embodiment, has an opening 21 at the same orientation. The lower combinative chest 20 is provided on the base 10. Each combinative chest 20 has a second end 22 at a periphery of a bottom thereof and a first end 23 at a periphery of a top thereof. The upper combinative chest 20 is stacked on the lower combinative chest 20 via the second end 22 of the upper combinative chest 20 attached on the first end 23 of the lower combinative chest 20. Each combinative chest 20 is provided with two first reinforced ribs 24 respectively at interior sides of two parallel sections, between which is the opening 21, and a second reinforced rib 25 at an interior side of a rear section, which is opposite to the opening 21. The first ribs 24 and the second rib 25 of the upper combinative chest 20 are stacked on the first ribs 24 and the second rib 25 of the lower combinative chest 20.

A lid 30 is provided on the top of the upper combinative chest 20. The lid 30 has a second end 31 at a periphery of a bottom thereof to be attached on the first end 23 of the upper combinative chest 20.

A plurality of coupling sets 40 are provided at the corners of the base 10, the combinative chests 20 and the lid 30 respectively. Each coupling set 40 has a first coupler 41 and a second coupler 42. The first couplers 41 are L-shaped angle irons projected from the corners of the first sides 12 and 23 of the base 10 and the combinative chests 20. The second couplers 42 are provided at the corners of the second sides 22 and 31 of the combinative chests 20 and the lid 30, each of which has a L-shaped slot 43 to insert the corresponding first coupler 41 therein. With the engagement of the first couplers 41 and the second couplers 42, the combinative chests 20 and the lid 30 is firmly stacked on the base 10 or the combinative chests 20 respectively. In other words, the first ends 12 and 23 are coupled with the second ends 22 and 31 respectively and no movement will take along the horizontal orientations. With the aforesaid structure, the tool storage kit of the present invention is completed.

In operation, as shown in FIG. 1 to FIG. 4, user stacks the combinative chests 20 (drawings show two combinative chests 20 being stacked) on the base 10 and put the lid 30 on the upper combinative chest 20. The first couplers 41 and the second couplers 42 of the coupling sets 40 are engaged with each other to attach second ends 22 and 31 on the first ends 12 and 23 to complete the assembly of the tool storage kit of the present invention. The number of the combinative chests 20 being stacked is based on the height of the workplace. It is a free option for user to choose how many combinative chests 20 to stack. The combinative chest 20 is provided with two rails 50 on the interior sides of the parallel sections thereof on which a drawer 51 is installed. The tools are put in the drawer 51 for storage and the drawer 51 can be drawn out for user to take the tools.

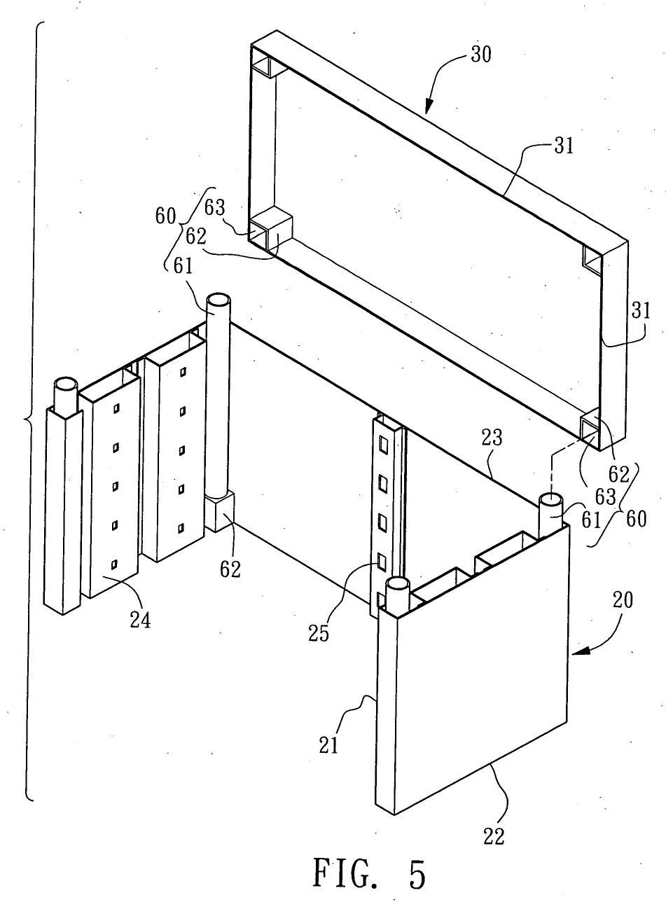

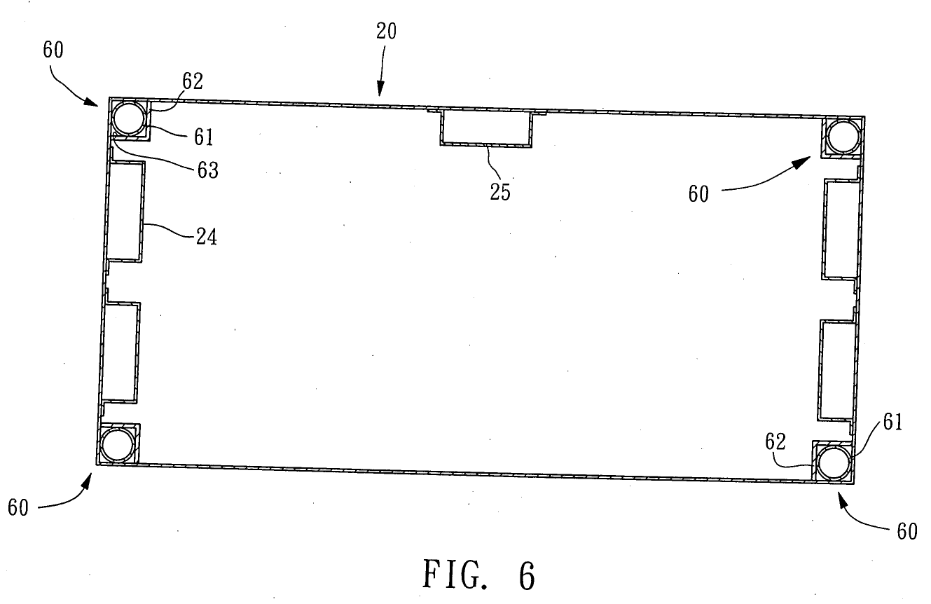

FIG. 5 and FIG. 6 show a tool storage kit of the second preferred embodiment of the present invention, which is similar to the storage kit of the first preferred embodiment. The tool storage kit of the second preferred embodiment has coupling sets 60, each of which has a first coupler 61 and a second coupler 62. The first coupler 61 is a column and the second coupler 62 is an L-shaped plate mounted at the corner of the second ends 22 or 31 in which a rectangular slot 63 is formed. The first couplers 61 are inserted into the corresponding slots 63 of the second couplers 62 to serves the functions of easy assembly and adjusting the height of the tool storage kit.

For the features of the present invention as described above, the present invention provides the elements, such as the base, the combinative chests and the lid, of the tool storage kit can be assembled and disassembled in an easier way. The stacked combinative chests are firmly restricted and no horizontal movement will take. The present invention also provides the first ends attached on the second ends of each element and the first reinforced ribs and the second reinforced ribs to enhance the strength. The tool storage kit of the present invention has an easy and better way of assembly and the strength is superior too. It provides users to assemble the very tool storage kit that meets his/her requirement by his/her own.

1. A tool storage kit, comprising:
a base having four wheels respectively at corners of a bottom thereof and a first end at a periphery of a top thereof;
at least a combinative chest to be stacked on the base having an opening, a second end at a periphery of a bottom thereof and a first end at a periphery of a top thereof, wherein the second end of the combinative chest is attached on the first end of the base;
a lid provided on the top of the combinative chest and having a second end at a periphery of a bottom thereof to be attached on the first end of the combinative chest, and
a plurality of coupling sets provided at corners of the base, the combinative chest and the lid respectively, each of which has a first coupler and a second coupler to be engaged with the first coupler, wherein the first couplers and the second couplers are disposed at corners of the first ends and the second ends respectively to couple the base, the combinative chest and the lid.

2. The tool storage kit as defined in claim 1, wherein two of the combinative chest are stacked on the base and the openings are orientated at a direction and the combinative chest at lower is stacked on the base and the lid is coupled with the combinative chest at upper.

3. The tool storage kit as defined in claim 1, wherein the combinative chest is provided with two first reinforced ribs respectively at interior sides of two parallel sections thereof.

4. The tool storage kit as defined in claim 1, wherein the combinative chest is provided with a second reinforced rib at an interior side of a rear section, which is opposite to the opening, thereof.

5. The tool storage kit as defined in claim 1, wherein the first couplers of the coupling sets are provided at the corners of the first ends and the second couplers are provided at the corners of the second ends respectively.

6. The tool storage kit as defined in claim 1, wherein the first couplers of the coupling sets are provided at the corners of the second ends and the second couplers are provided at the first corners of the ends respectively.

7. The tool storage kit as defined in claim 1, wherein the first coupler of the coupling set is an L-shaped angle iron and the second coupler has an L-shaped slot to receive the first coupler therein.

8. The tool storage kit as defined in claim 1, wherein the first coupler of the coupling set is a column and the second coupler is an L-shaped plate mounted at the corner to form a rectangular slot therein, such that the first coupler is inserted into the slot of the second coupler.
